(19) United States
(12) Patent Application Publication
(10) Pub. No.: US 2026/0087242 A1
(43) Pub. Date: Mar. 26, 2026

(54) DATA ASSESSMENT DOCUMENT GENERATION

(71) Applicant: International Business Machines Corporation, Armonk, NY (US)

(72) Inventors: Sima NADLER, Tel Aviv (IL); Shlomit KOYFMAN, Qiryat Yam (IL); Eliot SALANT, Haifa (IL); Victoria GOLDIN, Haifa (IL)

(21) Appl. No.: 18/895,213

(22) Filed: Sep. 24, 2024

(51) Int. Cl. G06F 40/174; G06F 8/71; G06F 21/62

(52) U.S. Cl. CPC G06F 40/174; G06F 8/71; G06F 21/6245

(57) ABSTRACT

In some implementations, a computing device may scan code of a software solution that uses data inputs or generates data and one or more datasets associated with the code, the scanning including identification of sensitive data if present. The computing device may generate a data assessment document automatically and based at least in part on the scanning. The data assessment document may be a machine-readable document, which may be used to generate a human-readable document. The data assessment document may be provided for approval based at least in part on completion of fields of the data assessment document. In some aspects, the code is not allowed to be merged into a main source control repository until the data assessment document is complete and approved.

### BACKGROUND

Data governance regulations require that organizations document use of personal data in documents such as Data Protection Impact Assessment (DPIA) or Privacy Impact Assessments (PIA), both of which are referred to as a data assessment document herein. A data assessment document is to indicate what data is processed, as part of what solution, and for what purpose. The data assessment document is also to indicate where the data is stored, what risks are involved, what risk mitigation has been taken, and who are stakeholders associated with the data or an associated software solution.

### SUMMARY

In some implementations, a method comprises scanning code of a software solution that uses data inputs and one or more datasets associated with the code, the scanning including identification of sensitive data if present. The method may also include generating a data assessment document automatically and based at least in part on the scanning.

In some implementations, a computer program product comprises one or more computer readable storage media and program instructions collectively stored on the one or more computer readable storage media. The program instructions may include program instructions to scan code of a software solution that uses data inputs and one or more datasets associated with the code, where the scanning includes identification of sensitive data if present. The program instructions may include program instructions to generate a machine-readable data assessment document based at least in part on the scanning.

In some implementations, a computer system comprises a processor set, one or more computer-readable storage media, and program instructions stored on the one or more storage medium to cause the processor set to perform operations. The operations comprise scanning code of a software solution that uses data inputs and one or more datasets associated with the code, where scanning includes identification of sensitive data if present. The operations comprise generating a data assessment document and based at least in part on the scanning The operations comprise detecting an update to the software solution. The operations comprise re-scanning the code of the software solution, where the re-scanning includes identification of sensitive data if present. The operations comprise generating an update to the data assessment document based at least in part on the re-scanning.

### BRIEF DESCRIPTION OF THE DRAWINGS

FIGS. 1A-1C are diagrams of an example implementation described herein.

FIG. 2 is a diagram of an example implementation described herein.

FIG. 3 is a diagram of an example computing environment in which systems and/or methods described herein may be implemented.

FIG. 4 is a diagram of example components of one or more devices of FIGS. 1 and 2.

FIGS. 5-7 are flowcharts of example processes associated with data assessment document generation.

### DETAILED DESCRIPTION

The following detailed description of example implementations refers to the accompanying drawings. The same reference numbers in different drawings may identify the same or similar elements.

Data governance regulations require that organizations document use of personal data in documents such as Data Protection Impact Assessment (DPIA) or Privacy Impact Assessments (PIA), both of which are referred to as a data assessment document herein. A data assessment document is to indicate what data is processed, as part of what solution, and for what purpose. The data assessment document is also to indicate where the data is stored, what risks are involved, what risk mitigation has been taken, and who are stakeholders associated with the data or an associated software solution.

Creation of the data assessment document may be performed at a first draft of the software solution, which may render the data assessment document incomplete for a final draft. Alternatively, the data assessment document may be performed after the final draft is complete, which may delay shipping of the software solution while the data assessment document is manually generated by several owners (e.g., developers, business owners, data owners, and/or legal departments, among other examples). Additionally, or alternatively, manual creation of the data assessment document may consume excess computing resources based at least in part on multiple iterative reviews among the several owners, transmitting of manual reminders to complete sections of the data assessment document, excess accesses of the data assessment document to check for completion, excess digital editing of the data assessment document to review input from other owners, or notifying multiple people that control the same input of the data assessment document, among other examples.

Additionally, the data assessment document may not be updated for any subsequent drafts or releases of the software solution and may not match a current release of the software solution. In some examples, a person that manually creates the data assessment document may not have been involved in the first draft of the software solution or in the planning of the software solution. In this case, the data assessment document may be inaccurate, which may cause violation of governance regulations.

In some aspects described herein, a computing device may generate (e.g., automatically) a data assessment document based at least in part on scanning code of a software solution that uses data assessment document inputs (e.g., to identify sensitive data, if present) and scanning of the metadata associated with the data and/or the data itself. In some aspects, the computing device may generate the data assessment document based at least in part on the software solution achieving a triggering state. For example, the computing device may generate the data assessment document based at least in part on the software solution being submitted through a development workflow. In some aspects, the computing device may generate the data assessment document based at least in part on pull request associated with a continuous integration process. In some aspects, the computing device may generate the data assessment document based at least in part on a change to the data or its metadata. In this way, the data assessment document may be generated as part of the ongoing development process and a “shift left” approach (e.g., generations as part of a development and continuous integration process) may be used to improve a likelihood that the document remains aligned with the code.

In some aspects, the data assessment document may be generated and updated as part of development (e.g., in a continuous integration (CI) process). In some aspects, the computing device may link creation of the data assessment document to the design and development of the software solution by linking the processes and tools used by users involved in the design and development of the software solution.

In some aspects, a developer may provide a pull request that automatically triggers the creation or update of the data assessment document. For example, the computing device (or an application associated with data assessment document generation) may be integrated with a source control system (e.g., Git or GitHub) and a continuous integration tool (e.g., Travis). The computing device may automatically populate assessment information that can be automatically discovered from the code and the repository in which it resides. The computing device may automatically request information from computing devices associated with relevant human actors (e.g., legal or business actors) who are not involved in the development effort, but whose input is associated with one or more fields of the data assessment document. The computing device may automatically use input from the computing devices associated with relevant human actors to populate the input in relevant sections of the data assessment document.

Based at least in part on generating the data assessment document automatically in connection with a scan of the code and its associated data, and/or updating code with an updated scan, the data assessment document may have improved accuracy for compliance with data governance. Additionally, or alternatively, computing resources may be conserved that may have otherwise been used for multiple iterative reviews among the several owners, transmitting of manual reminders to complete sections of the data assessment document, excess accesses of the data assessment document to check for completion, excess digital editing of the data assessment document to review input from other owners, or notifying multiple people that control the same input of the data assessment document, among other examples.

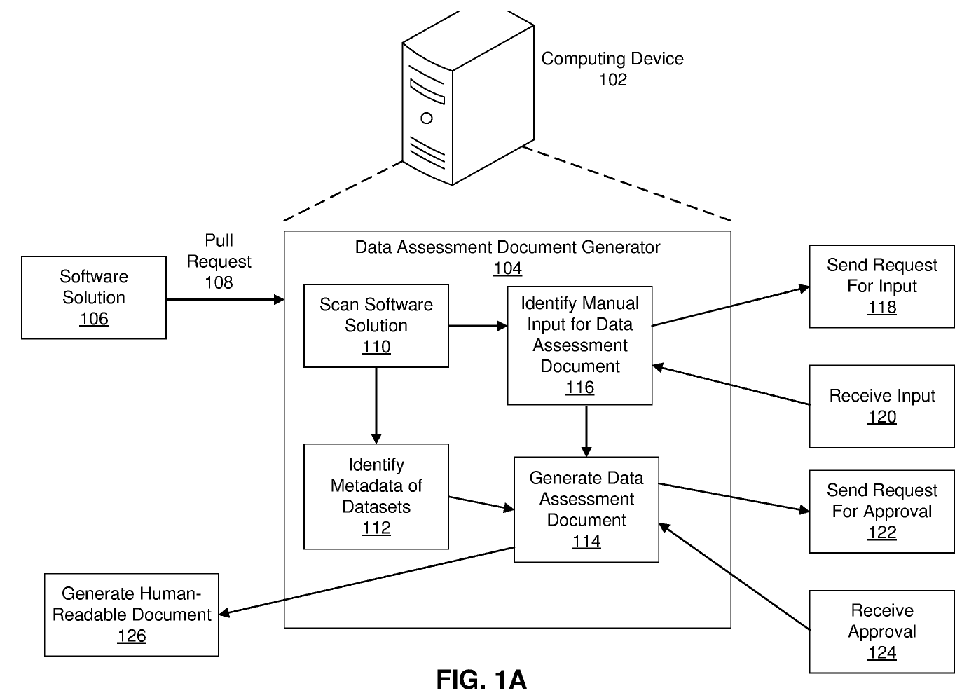

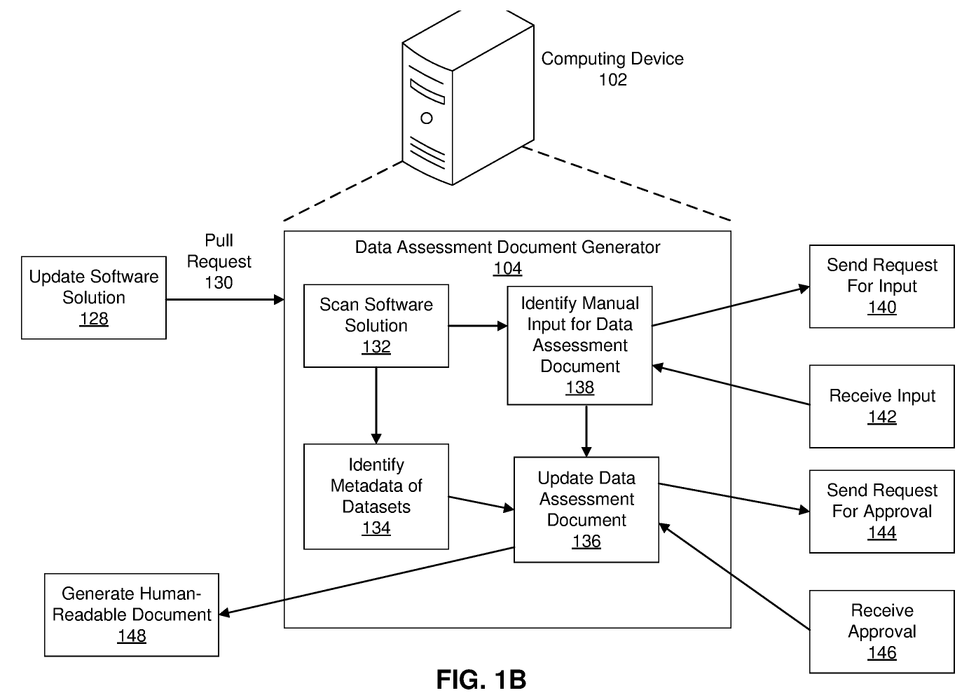

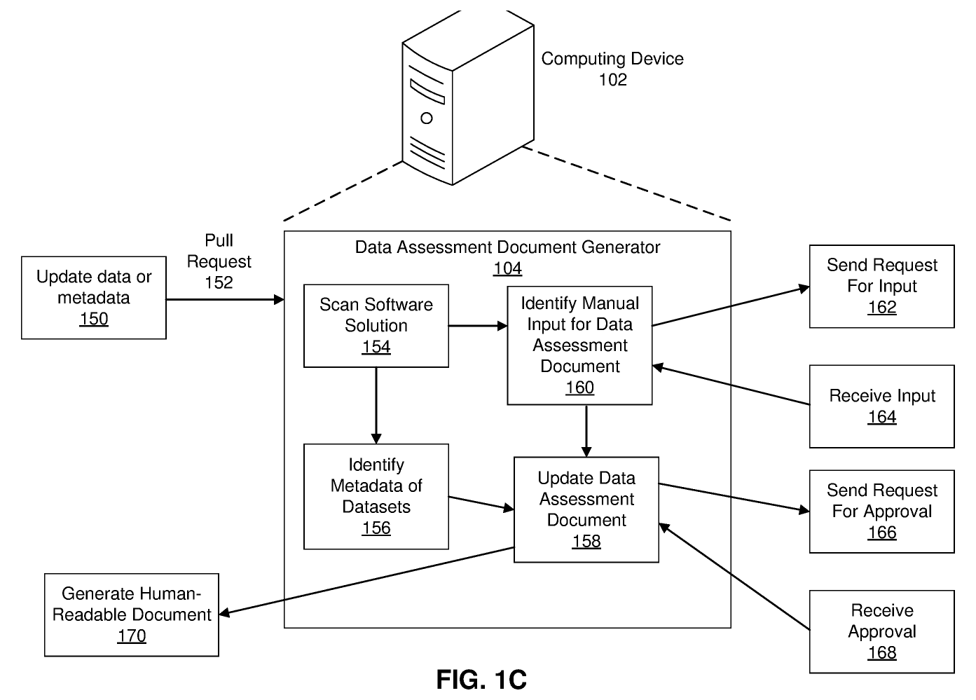

FIGS. 1A-1C are diagrams of an example implementation 100 described herein. As shown in FIGS. 1A-1C, example implementation 100 includes a computing device 102 and a data assessment document generator 104 operating thereon. In some aspects, the computing device 102 may include a development workflow application or may communicate with a development workflow application operating at a different computing device.

As shown in FIG. 1A, a software solution 106 may be associated with a pull request 108. The pull request 108 may be associated with a request to incorporate changes (e.g., an update or addition) to a main project branch (e.g., a current or formal version of a software solution).

As shown by reference number 110, the data assessment document generator 104 may scan the software solution 106. The data assessment document generator 104 may scan datasets associated with code of the software solution 106. For example, scanning the software solution 106 may include scanning code (e.g., source code) of the software solution 106 and scanning one or more data sets (e.g., read or written datasets) associated with the code. In some aspects, the data assessment document generator 104 may scan the software solution 106 as part of a continuous integration process that is triggered based at least in part on the pull request 108.

In some aspects, the data assessment document generator 104 may directly scan code (e.g., source code) of the software solution 106 to identify the read and/or written datasets or may receive the results of the scan from another computing device. In some aspects, the computing device or the other computing device 102 may define language-specific configuration files that define observed functions and the way to obtain desired attributes (e.g., file/endpoint/bucket name, read/write access, among other examples).

In some aspects, the scan may include parsing the codebase and representing the codebase as syntax trees. The scan may include propagating constant strings into built-in or user function calls and traversing syntax trees. For a function call that is defined in the configuration file, the scan may include retrieving attributes and access type (read/write) associated with the codebase, while tracking the affecting objects and functions. The scan may match (e.g., using heuristics) a locally cached file to a remote object and return the collected information as pairs of access type and dataset location.

In some aspects, the computing device 102 may pass an indication of a URL for a given dataset to a dataset metadata scanner. The metadata scanner may receive an associated file (e.g., a json) file that includes one or more of a field holding the URL or a dataset type (e.g., indicating whether a data source is an S3-cloud store, a database, or a file in a Git repository, among other examples). The scanner may extract the URL from this field. If the data source is an S3-cloud store, then S3 credentials (e.g., S3 access and S3 secret keys) may be passed as input parameters to this data scanner function. The metadata to be extracted identifies the dataset size and location of the data store. If the dataset type is S3 (e.g., if an associated URL of the dataset contains the string, “s3”) then the computing device 102 may programmatically use software APIs to create an S3 client that connects to a remote S3 store. The passed S3 credentials (e.g., access and secret keys) may be used to establish a session with the remote S3 server. The S3 API for obtaining a file size for a given URL may be used to identify a file size.

In some aspects, a geographical location of the data store may be obtained by using an operating system command to translate the URL to an IP address (e.g., including a country code associated with the IP address).

As shown by reference number 112, the data assessment document generator 104 may identify metadata of datasets identified within the software solution 106 based at least in part on the scan described in connection with reference number 110. Once datasets are identified via the scan, the data assessment document generator 104 may automatically generate metadata, such as levels of sensitivity, about the datasets and the details of the datasets and metadata may be automatically populated into a data assessment document (e.g., the machine-readable document). The automatically populated information may be overridden by manual overriding (e.g., human input) into fields of the data assessment document.

As shown by reference number 114, the data assessment document generator 104 may generate the data assessment document. In some aspects, the data assessment document generator 104 may generate the data assessment document based at least in part on metadata of the one or more datasets.

In some aspects, the computing device 102 may generate the data assessment document as a machine-readable document. For example, the data assessment document may include a yaml-based or json-based representation with a json taxonomy for validating the yaml or json-based document. In some aspects, the machine-readable document may have a structure that is customizable, extendable, and/or extensible, among other examples.

The machine-readable document may include sections and fields associated with the data assessment document, as well as the valid values for populating many of the fields. Valid values may be populated by individual enterprises associated with their industry and specific business and technical environment. The machine-readable document may include one or more indicators of the roles or people who may provide information for specific fields or sections, or who are permitted to override automatically generated information. Additionally, or alternatively, the machine-readable document may provide a mechanism for capturing which fields were populated automatically and by which process. Further, the machine-readable document may provide a mechanism for enabling a user to override an automatically-populated field. The manual value may be prevented from overriding in a future version of the data assessment document (e.g., prevented from being overridden to an automated value of the field).

In some aspects, the data assessment document (e.g., the machine-readable document) may include (e.g., for each dataset or intermediate datasets) solution or model information. For example, the data assessment document may include one or more of model information (e.g., associated with a machine learning (ML) or artificial intelligence (AI) model that uses inputs from user information or other potentially sensitive data), a model and version and description, a link to a source control repository, an indication of geographies where model the will be deployed, a purpose of use, a legal basis for use, and/or a project or business owner, among other examples. In some aspects, the machine-readable document may include a link to the source data, such as source data associated with the user information or other potentially sensitive data, or other source data that does not include sensitive data.

In some aspects, the data assessment document may include, for respective datasets, a source link, a manual, a data protection officer (DPO) providing approval for use of dataset for training of particular model, project or business owner approving the data for use in training the particular model. The data assessment document may indicate risk mitigation techniques, links to models, or indicate whether datasets are shared with third parties, among other examples. In some aspects, the data assessment document may indicate, from a data catalog, a data range of collection of the dataset, technical information (e.g., format, data store and endpoint for accessing the data, and/or a link to credentials, among other examples), geography from which the dataset was taken and geography where the data resides, a license for use of the dataset, a size of the dataset, types of sensitive data included in the dataset (e.g., PII, SPII, or confidential, among other examples), and/or a computed sensitivity score, or data risk score, among other examples.

In an example operation algorithm for generating the data assessment document, the computing device 102 may load an existing data assessment document (e.g., DPIA) or create an empty new data assessment document. The computing device 102 may scan source code of the software solution to identify datasets (e.g., read or written) and, on respective datasets, use a data scan tool to identify dataset metadata using the dataset’s location, and populate fields in the data assessment document with the dataset’s metadata such as classifications and sensitivities of the data. If running as part of a CI, for respective people that take part in filling the data assessment document, the computing device 102 may identify what fields in the data assessment document are associated with the person, open for the person a development workflow (e.g., GitHub) issue with a request to provide the missing information in the identified fields, and link the issue to the developer’s pull request to represent the connection to the development process, among other examples. If the data assessment document is complete (e.g., with a threshold amount of completed fields and/or responses from people associated with the data assessment document), the computing device 102 may request stakeholders’ approval of the final data assessment document (e.g., using GitHub or another development workflow).

In some aspects, metadata of the datasets may be automatically populated into a data assessment document (e.g., the machine-readable document). The automatically populated information may be overridden by manual overriding (e.g., human input) into fields of the data assessment document.

As shown by reference number 116, the data assessment document generator 104 may identify manual input for the data assessment document. For example, the data assessment document generator 104 may determine that the data assessment document is incomplete after populating the data assessment document with only automatically generated information (e.g., metadata of the datasets). For fields that are missing, the data assessment document generator 104 may create issues within the development workflow (e.g., github issues).

To improve synchronization between technical code written by developers, and business and legal information applied into the data assessment document, the data assessment document generator 104 may use a mechanism for linking the processes and systems of these different actors. For example, a developer may use a standard source control tool (e.g., Git or Github, among other examples) and business and legal actors may use standard GRC tools (e.g., OpenPages).

To generate an issue within the development workflow, the data assessment document generator 104 may loop over a list of roles (e.g., legal, dev, bus, data owner) and create a list of missing fields for a particular role. The data assessment document generator 104 may loop over all of the fields in the machine-readable document (e.g., dpia.yaml) that do not have values. If the field is to be handled by the current role, add it to the role’s list of missing fields. In some aspects, the data assessment document generator 104 may indicate whether the field is mandatory or optional.

The data assessment document generator 104 may create an issue title and/or indicate a role name, that input is required from the role, and the related pull request. The data assessment document generator 104 may create the issue body, including creating a summary of the data assessment document with a solution description, datasets used and generated, and/or a level of sensitivity of the datasets. The data assessment document generator 104 may further create the issue body including displaying the list of missing fields, names of the fields, valid values (if not free text) from a valid values schema, and/or an indicator if respective fields are mandatory.

The data assessment document generator 104 may link the issue to the developer’s pull request, which may prevent the pull request from being merged without resolving the issue. In some aspects, the data assessment document generator 104 may call the GitHub API to create a new issue and add a tag (e.g., “data assessment document” or “DPIA”) to the issue to indicate that the issue is associated with the assessment document and not the code. The data assessment document generator 104 may assign the issue to the relevant person in the given role (e.g., GitHub teams can be used to indicate people of a particular role).

For each issue, the data assessment document generator 104 may open an issue in a “home” tool of a relevant actor (e.g., OpenPages for legal). The data assessment document generator 104 may wait for completion events. When received, the data assessment document generator 104 may update the issue with the content received. The developer may receive updates, via an associated computing device, when issues are updated (e.g., via the computing device 102, the data assessment document generator 104, and/or development workflow tool, among other examples). A computing device associated with the developer may run a tool that takes the content from the issues, and automatically updates the data assessment document (e.g., the machine-readable document). In some aspects, information collected associated with manual input may be automatically added to the data assessment document without additional manual input (e.g., from the developer).

As shown by reference number 118, the data assessment document generator 104 may send a request for input to a party associated with input requested for the data assessment document. For example, the data assessment document generator 104 may create an issue within a development workflow that provides the request for input. In some aspects, the data assessment document generator 104 may send the request for input to a computing device associated with a person identified as having information associated with manual input for the data assessment document.

In some aspects, the data assessment document generator 104 may identify contact information for the person (or one or more additional people) as having the information associated with the manual input (e.g., for one or more manual fields) for the data assessment document. For example, the data assessment document generator 104 may identify the contact information via input from a user, a field of the software solution 106, metadata of the software solution, the datasets identified in connection with reference number 112, or via an additional computing device.

As shown by reference number 120, the data assessment document generator 104 may receive input for the data assessment document. In some aspects, the data assessment document generator 104 may receive the input from the person or another person with which the person shared the request for input. In some aspects, the data assessment document generator 104 may receive the input and an indication of one or more additional people that may have information associated with the manual input for the data assessment document. In some aspects, the indication of one or more additional people may include an indication of contact information (e.g., for electronic communication) associated with the one or more additional people. In some aspects, the data assessment document generator 104 may send the request for input 118 to the one or more additional people based at least in part on receiving the indication of the one or more additional people.

As shown in FIG. 1A, the manual input may be used to generate the data assessment document. For example, information from the manual input may be added to a draft, or a preliminary version, of the data assessment document. In some aspects, manual input may be used to override automated input. In some aspects, a field with manual input that overrides automatic input may be restricted from automated input in a subsequent version of the data assessment document following an update to the code and/or an updated scan.

As shown by reference number 122, the data assessment document generator 104 may send a request for approval for the data assessment document. For example, the data assessment document generator 104 may send the request based at least in part on detection of completion of the data assessment document (e.g., a threshold level of completion). In some aspects, the data assessment document generator 104 may use a development workflow application to provide the request for approval. In some aspects, the data assessment document generator 104 may send the request for approval to a computing device associated with a person having a role or credentials associated with approving the data assessment document.

In some aspects, the data assessment document generator 104 may identify contact information for one or more people having the role or credentials associated with approving the data assessment document. For example, the data assessment document generator 104 may identify the contact information via input from a user, a field of the software solution 106, metadata of the software solution, the datasets identified in connection with reference number 112, or via an additional computing device.

In some aspects, the computing device 102 may automatically identify completion (e.g., full or nearly full population of fields) of the data assessment document and trigger an approval process. For example, relevant actors may be assigned, through their associated computing devices and/or using associated credentials, to review the assessment document and provide approval.

In some aspects, a pull request may be approved only after the data assessment document is complete and assessment reviewers have approved. In this way, the data assessment document may be kept up to date with a true state of the software solution.

As shown by reference number 124, the data assessment document generator 104 may receive the approval. Upon receiving approval, the data assessment document may be considered a complete data assessment document for a current state of the software solution 106.

As shown by reference number 126, the data assessment document generator 104 may generate a human-readable document associated with the data assessment document (e.g., a human-readable version of the data assessment document).

For example, the machine-readable document (e.g., a yaml document) may be loaded into a structure for a data assessment document. The data assessment document may generate, or cause to be generated, a human-readable (e.g., PDF) document with the information from the data assessment document. The document may include sections on processing details (e.g., describing a solution sub-structure) and <dataset name> for respective dataset objects. Respective sections may include a table containing a field name, a description (e.g., from the json schema of the data assessment document) and a value (e.g., from the loaded structure). For risk fields, table rows may appear in colors representing a risk severity from green (Low) to red (High). The document may also include a section for stakeholders that includes names and roles of approvers and required approvers, as well as approval status (e.g., approved or not approved).

As shown in FIG. 1B, an update to the software solution 128 may be associated with a pull request 130 provided to the data assessment document generator 104.

As shown by reference number 132, the data assessment document generator 104 may scan the updated software solution based at least in part on the pull request 130. In some aspects, the data assessment document generator 104 may scan the updated software solution based at least in part on a request to merge the code into a main source control repository. For example, the code of the software solution may be a part of a larger software product into which the code is to be integrated once completed with an approved data assessment document.

As shown by reference number 134, the data assessment document generator 104 may identify metadata of datasets identified within the update to the software solution 128 based at least in part on the scan described in connection with reference number 132. Once datasets are identified via the scan, the data assessment document generator 104 may automatically generate metadata about the datasets and the details of the datasets and the metadata may be automatically populated into the data assessment document (e.g., an update to the machine-readable document). The automatically populated information may be prohibited from being populated to one or more fields of the data assessment document that previously received manual overriding (e.g., human input).

As shown by reference number 136, the data assessment document generator 104 may generate an update to the data assessment document (e.g., update the data assessment document). In some aspects, the computing device 102 may update the data assessment document as a machine-readable document.

In some aspects, the data assessment document generator 104 may update the data assessment document based at least in part on an update to the code, an updated scan of the code, a request to update the data assessment document, an updated scan of the one or more datasets associated with the code, a change of a size of the one or more datasets, a change of a location of the one or more datasets, or an update to identification of sensitive data, among other examples.

As shown by reference number 138, the data assessment document generator 104 may identify manual input for the data assessment document. For example, the data assessment document generator 104 may determine that the updated data assessment document is incomplete after populating the data assessment document with only automatically generated information (e.g., metadata of the datasets). For example, new datasets may have been included in the updated software solution 128 for which automated input is incomplete.

As shown by reference number 140, the data assessment document generator 104 may send a request for input to a party associated with input requested for updating the data assessment document. For example, the data assessment document generator 104 may create an issue within a development workflow that provides the request for input. In some aspects, the data assessment document generator 104 may send the request for input to a computing device associated with a person identified as having information associated with manual input for the data assessment document. As shown by reference number 142, the data assessment document generator 104 may receive input for updating the data assessment document.

As shown in FIG. 1B, the manual input may be used to update the data assessment document. In some aspects, manual input may be used to override automated input of the updated version of the data assessment document.

As shown by reference number 144, the data assessment document generator 104 may send a request for approval for the data assessment document. For example, the data assessment document generator 104 may send the request based at least in part on detection of completion of the data assessment document (e.g., a threshold level of completion). In some aspects, the data assessment document generator 104 may use a development workflow application to provide the request for approval. In some aspects, the data assessment document generator 104 may send the request for approval to a computing device associated with a person having a role or credentials associated with approving the data assessment document.

In some aspects, the data assessment document generator 104 may send the request for approval based at least in part on a change to a previous version of the data assessment document being a major change. In some aspects, re-approval may be unnecessary. For example, rather than triggering a request for re-approval when changes to the code or scan do not materially impact a data assessment, the computing device 102 may determine that re-approval may be skipped.

In some aspects, the computing device 102 may compare two populated data assessment document evaluations, representing the original and the updated version. The computing device 102 may determine whether a change is a major change associated with reapproval or a minor change that is not associated with reapproval (e.g., but is to be a saved change). Different fields of the data assessment document may have different rules for categorizing a change as a major change or a minor change. For example, no changes are major in some fields, any change is major for other fields, and a change must satisfy a threshold condition (e.g., associated with a number of changed characters) to be major in others.

In some aspects, the computing device 102 may use an indication of a first list of fields for which changes are not classified as major, a second list of fields for which any changes are classified as major, and/or a third list of fields for which changes may be classified as major if a threshold condition is satisfied. For example, the computing device 102 may review an updated data assessment document with changed fields. For a changed field, the computing device 102 may use a decision tree of “does the change satisfy the threshold? If no, is the change in a zero-changes-list? If yes, then the change is major. If no, then the change is minor.” If the change does satisfy the threshold, then “is the change in a major-exclusions-list? If yes, then the change is minor. If no, then the change is major.”

As shown by reference number 146, the data assessment document generator 104 may receive the approval. Upon receiving approval, the data assessment document may be considered a complete data assessment document for a current state of the software solution 106.

As shown by reference number 148, the data assessment document generator 104 may generate a human-readable document associated with the data assessment document (e.g., a human-readable version of the data assessment document). In some aspects, the human-readable document may be formatted as a digital document that is configured for display via a computing device, such as a PDF or word processing file. In some aspects, the computing device 102 may provide the human-readable document to a computing device associated with the developer or another interested party.

As shown in FIG. 1C, an update to the data or metadata 150 may trigger an update to the data assessment document generator 104. In some aspects, the update to the data or metadata 150 may include, for example, a change to a size, a sensitivity, or a classification of the data without necessarily having any changes to the code itself. In some aspects, the computing device 102 may identify the update to the data or metadata based at least in part on a rescan of the code or data or a pull request 152, among other examples. In some aspects, the computing device 102 may initiate the update to the data assessment document generator 104 that is based at least in part on the update to the data or metadata 150 without a pull request 152.

As shown by reference number 154, the data assessment document generator 104 may scan the software solution, based at least in part on the pull request 152 or identification of an update to the data or the metadata. In some aspects, the data assessment document generator 104 may not perform a scan of the software solution 154 when the update to the data assessment document generator 104 is based at least in part on an update to the data or metadata 150 (e.g., scanning the software solution may be optional if the trigger for the update is an update to the data or metadata 150).

As shown by reference number 156, the data assessment document generator 104 may identify metadata of datasets identified within the update to the data or metadata 150. Once datasets are identified via the scan, the data assessment document generator 104 may automatically generate metadata about the datasets and the details of the datasets and the metadata may be automatically populated into the data assessment document (e.g., an update to the machine-readable document). The automatically populated information may be prohibited from being populated to one or more fields of the data assessment document that previously received manual overriding (e.g., human input).

As shown by reference number 158, the data assessment document generator 104 may generate an update to the data assessment document (e.g., update the data assessment document). In some aspects, the computing device 102 may update the data assessment document as a machine-readable document.

As shown by reference number 160, the data assessment document generator 104 may identify manual input for the data assessment document. For example, the data assessment document generator 104 may determine that the updated data assessment document is incomplete after populating the data assessment document with only automatically generated information (e.g., metadata of the datasets). For example, updated data or metadata 150 may trigger updated information for the data assessment document generator 104, with automated input from the data assessment document generator 104 being incomplete.

As shown by reference number 162, the data assessment document generator 104 may send a request for input to a party associated with input requested for updating the data assessment document. For example, the data assessment document generator 104 may create an issue within a development workflow that provides the request for input. In some aspects, the data assessment document generator 104 may send the request for input to a computing device associated with a person identified as having information associated with manual input for the data assessment document. As shown by reference number 164, the data assessment document generator 104 may receive input for updating the data assessment document.

As shown in FIG. 1C, the manual input may be used to update the data assessment document. In some aspects, manual input may be used to override automated input of the updated version of the data assessment document.

As shown by reference number 166, the data assessment document generator 104 may send a request for approval for the data assessment document. For example, the data assessment document generator 104 may send the request based at least in part on detection of completion of the data assessment document (e.g., a threshold level of completion). In some aspects, the data assessment document generator 104 may use a development workflow application to provide the request for approval. In some aspects, the data assessment document generator 104 may send the request for approval to a computing device associated with a person having a role or credentials associated with approving the data assessment document.

In some aspects, the data assessment document generator 104 may send the request for approval based at least in part on a change to a previous version of the data assessment document being a major change. In some aspects, re-approval may be unnecessary. For example, rather than triggering a request for re-approval when changes to the code or scan do not materially impact a data assessment, the computing device 102 may determine that re-approval may be skipped.

In some aspects, the computing device 102 may compare two populated data assessment document evaluations, representing the original and the updated version. The computing device 102 may determine whether a change is a major change associated with reapproval or a minor change that is not to be sent for reapproval (e.g., but is to be a saved change). Different fields of the data assessment document may have different rules for categorizing a change as a major change or a minor change. For example, no changes are major in some fields, any change is major for other fields, and a change must satisfy a threshold condition (e.g., associated with a number of changed characters) to be major in others.

In some aspects, the computing device 102 may use an indication of a first list of fields for which changes are not classified as major, a second list of fields for which any changes are classified as major, and/or a third list of fields for which changes may be classified as major if a threshold condition is satisfied. For example, the computing device 102 may review an updated data assessment document with changed fields. For a changed field, the computing device 102 may use a decision tree of “does the change satisfy the threshold? If no, is the change in a zero-changes-list? If yes, then the change is major. If no, then the change is minor.” If the change does satisfy the threshold, then “is the change in a major-exclusions-list? If yes, then the change is minor. If no, then the change is major.”

As shown by reference number 168, the data assessment document generator 104 may receive the approval. Upon receiving approval, the data assessment document may be considered a complete data assessment document for a current state of the software solution 106.

As shown by reference number 170, the data assessment document generator 104 may generate a human-readable document associated with the data assessment document (e.g., a human-readable version of the data assessment document). In some aspects, the human-readable document may be formatted as a digital document that is configured for display via a computing device, such as a PDF or word processing file. In some aspects, the computing device 102 may provide the human-readable document to a computing device associated with the developer or another interested party.

As indicated above, FIGS. 1A-1C are provided as an example. Other examples may differ from what is described with regard to FIGS. 1A-1C. The number and arrangement of devices shown in FIGS. 1A-1C are provided as an example.

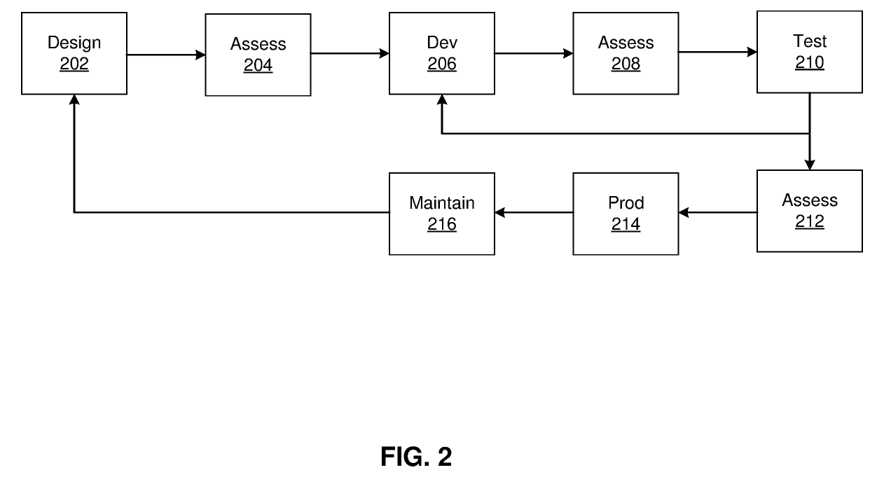

FIG. 2 is a diagram of an example implementation 200 described herein. As shown in FIG. 2, example implementation 200 includes a workflow path for development. As shown in FIG. 2, development of a software solution may include design operation 202 followed by a first assess operation 204 to evaluate the software solution for sensitive data in compliance, which may include generating a data assessment document.

The development processes may include a development operation 206, which may include generating source code for the software solution. Based at least in part on a trigger associated with the development operation 206 (e.g., initiating a pull request), a computing device may perform an additional assess operation 208. The assess operation 208 may include automatically generating a data assessment document, as described herein.

The development process may include a testing operation 210. When errors are detected, or additional features are to be added, the development process may return to the development operation 206. The development operation 206 may produce an update to the software solution, which may trigger an updated assessment at the assess operation 208.

Upon successful testing, another assess operation 212 may be performed to check for updates to the data assessment document. The data assessment document may be finalized and/or submitted to a controlling party or government agency along with production (prod) operation 214. While in production 214, developers may perform maintenance in a maintain operation 216. While in the maintain operation 206, developers may identify additional features to design, which may return the development process to the design operation 202. The developers may update the code to add new features or updates to the software solution, which may trigger further assess operations.

In this way, the data assessment document may be maintained along with updates and changes to the software solution, which may support compliance with regulatory requirements. Further, computing resources may be conserved based at least in part on automating generation of the data assessment document rather than manually creating the data assessment document, which may use excessive communications, check-ins, and duplicative computing commands to complete.

As indicated above, FIG. 2 is provided as an example. Other examples may differ from what is described with regard to FIG. 2. The number and arrangement of devices shown in FIG. 2 are provided as an example.

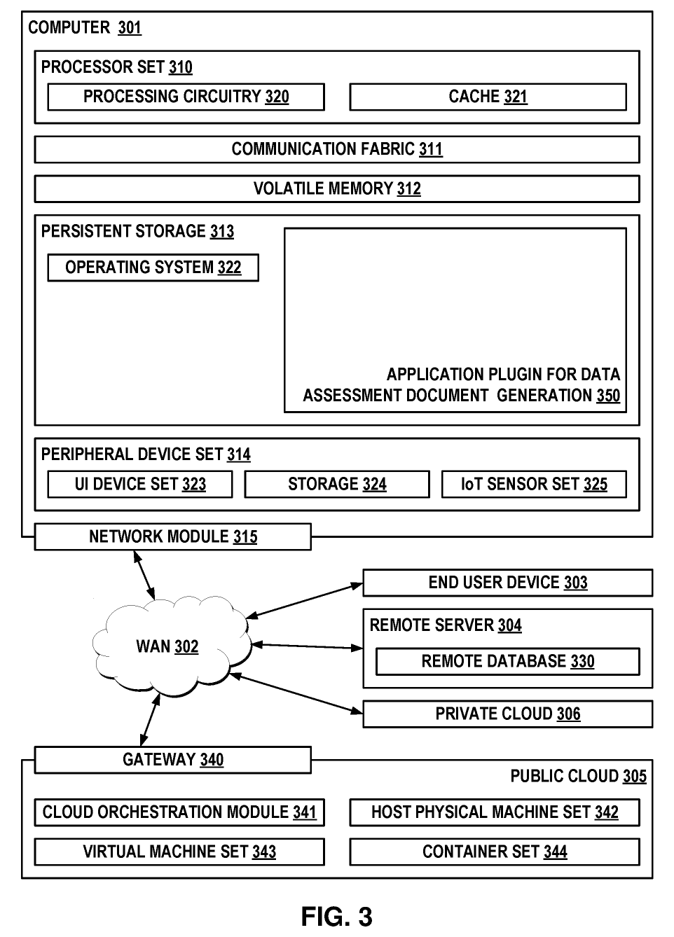

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as application plugin for data assessment document generation 350. In addition to application plugin for cross-cloud VPE operations 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and application plugin for cross-cloud VPE operations 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in application plugin for cross-cloud VPE operations 350 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in application plugin for cross-cloud VPE operations 350 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

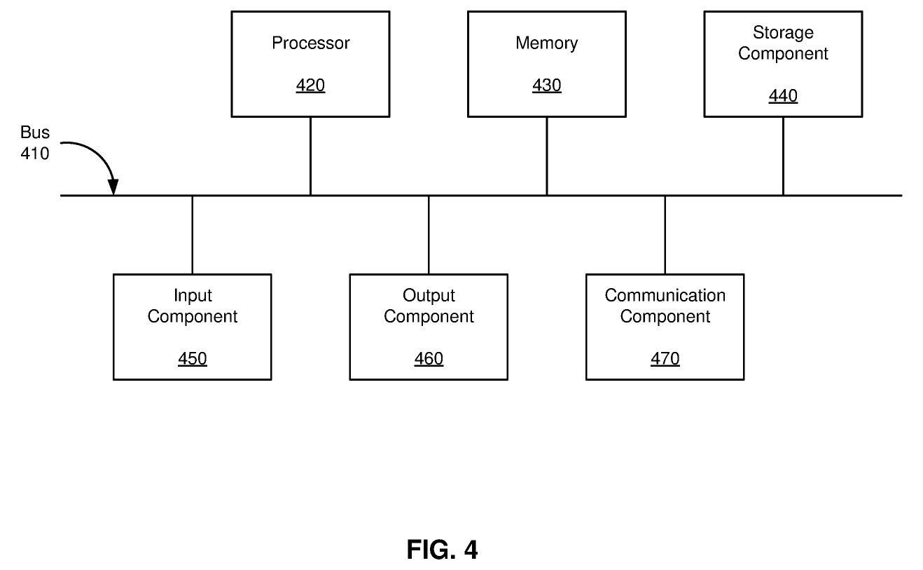

FIG. 4 is a diagram of example components of a device 400, which may correspond to the computing device 102 or data assessment document generator 104, among other examples. In some implementations, the computing device 102 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may be a repository that stores a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

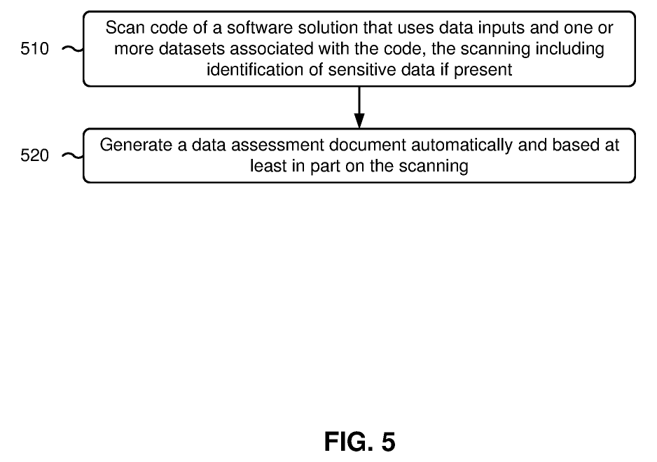

FIG. 5 is a flowchart of an example process 500 associated with data assessment document generation. In some implementations, one or more process blocks of FIG. 5 may be performed by a computing device (e.g., computing device 102 and/or data assessment document generator 104. Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include scanning code of a software solution that uses data inputs and one or more datasets associated with the code, the scanning including identification of sensitive data if present (block 510). For example, the computing device may scan code of a software solution that uses data inputs and one or more datasets associated with the code, the scanning including identification of sensitive data if present, as described above.

As further shown in FIG. 5, process 500 may include generating a data assessment document automatically and based at least in part on the scanning (block 520). For example, the computing device may generate a data assessment document automatically and based at least in part on the scanning, as described above.

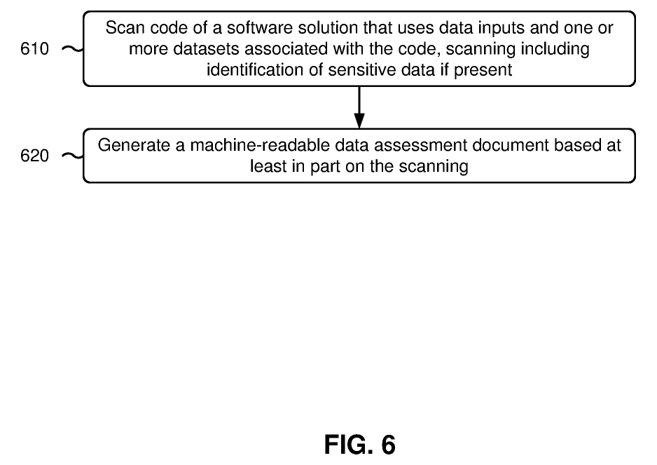

FIG. 6 is a flowchart of an example process 600 associated with data assessment document generation. In some implementations, one or more process blocks of FIG. 6 may be performed by a computing device (e.g., computing device 102 and/or data assessment document generator 104. Additionally, or alternatively, one or more process blocks of FIG. 6 may be performed by one or more components of device 400, such as processor 420, memory 430, storage component 440, input component 450, output component 460, and/or communication component 470.

As shown in FIG. 6, process 600 may include scanning code of a software solution that uses data inputs and one or more datasets associated with the code, the scanning including identification of sensitive data if present (block 610). For example, the computing device may scan code of a software solution that uses data inputs and one or more datasets associated with the code, the scanning including identification of sensitive data if present, as described above.

As further shown in FIG. 6, process 600 may include generating a machine-readable data assessment document and based at least in part on the scanning (block 620). For example, the computing device may generate a machine-readable data assessment document based at least in part on the scanning, as described above.

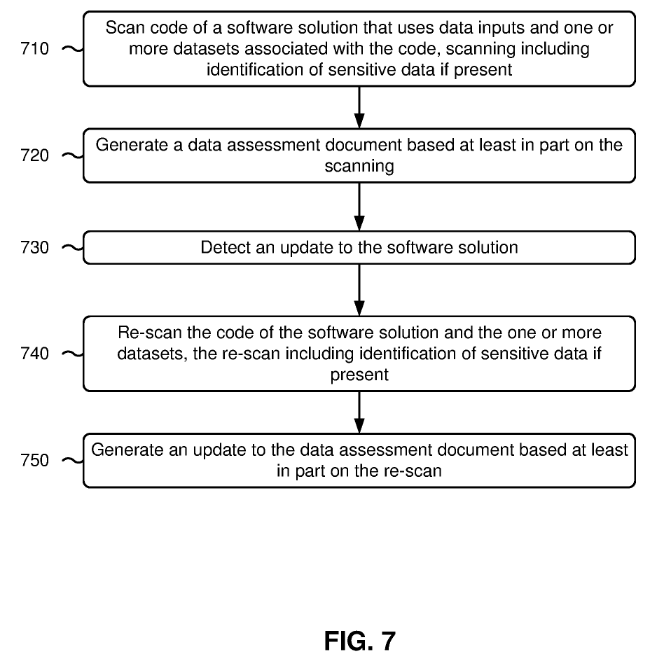

FIG. 7 is a flowchart of an example process 700 associated with data assessment document generation. In some implementations, one or more process blocks of FIG. 7 may be performed by a computing device (e.g., computing device 102 and/or data assessment document generator 104. Additionally, or alternatively, one or more process blocks of FIG. 7 may be performed by one or more components of device 400, such as processor 420, memory 430, storage component 440, input component 450, output component 460, and/or communication component 470.

As shown in FIG. 7, process 700 may include scanning code of a software solution that uses data inputs and one or more datasets associated with the code, the scanning including identification of sensitive data if present (block 710). For example, the computing device may scan code of a software solution that uses data inputs and one or more datasets associated with the code, the scanning including identification of sensitive data if present, as described above.

As further shown in FIG. 7, process 700 may include generating a data assessment document based at least in part on the scanning (block 720). For example, the computing device may generate a data assessment document based at least in part on the scanning, as described above.

As further shown in FIG. 7, process 700 may include detecting an update to the software solution (block 730). For example, the computing device may detect the update to the software solution, as described above.

As further shown in FIG. 7, process 700 may include rescanning the code of the software solution and the one or more datasets associated with the code, the re-scanning including identification of sensitive data if present (block 740). For example, the computing device may re-scan the code of the software solution and the one or more datasets associated with the code to identify sensitive data if present, as described above.

As further shown in FIG. 7, process 700 may include generating an update to the data assessment document based at least in part on the re-scanning (block 750). For example, the computing device may an update to the data assessment document based at least in part on the re-scanning, as described above.

Any of process 500, 600 or 700 may include additional implementations, such as any single implementation or any combination of implementations described below and/or in connection with one or more other processes described elsewhere herein.

In a first implementation, any of processes 500, 600, or 700 includes updating the data assessment document based at least in part on one or more of an update to the code, an updated scan of the code, a request to update the data assessment document, an updated scan of the one or more datasets associated with the code, a change of a size of the one or more datasets, a change of a location (e.g., geographical location or computer-based address) of the one or more datasets, or an update to identification of sensitive data.

In a second implementation, alone or in combination with the first implementation, any of processes 500, 600, or 700 includes detecting the update to the code based at least in part on one or more of submission of an update to the software solution, or reception of an input that indicates the update of the code.

In a third implementation, alone or in combination with one or more of the first and second implementations, scanning the code and the one or more datasets is based at least in part on one or more of submission of the code as a draft in a development workflow, or a request to merge the code into a main source control repository.

In a fourth implementation, alone or in combination with one or more of the first through third implementations, the one or more datasets comprise one or more read datasets used as data inputs or in one or more written datasets.

In a fifth implementation, alone or in combination with one or more of the first through fourth implementations, scanning the one or more datasets comprises detecting whether sensitive data is present based at least in part on metadata of the one or more datasets, wherein generating the data assessment document comprises populating one or more fields of the data assessment document with the metadata.

In a sixth implementation, alone or in combination with one or more of the first through fifth implementations, generating the data assessment document comprises generating the data assessment document as a machine-readable document.

In a seventh implementation, alone or in combination with one or more of the first through sixth implementations, the machine-readable document comprises indications of sensitive data if present, and metadata associated with the one or more datasets.

In an eighth implementation, alone or in combination with one or more of the first through seventh implementations, the data assessment document comprises one or more fields having input automatically inserted based at least in part on the sensitive data if present, one or more fields associated with manual input.

In a ninth implementation, alone or in combination with one or more of the first through eighth implementations, any of processes 500, 600, or 700 includes identifying contact information for a person associated with the one or more manual fields, and sending, via the contact information, a request for the manual input.

In a tenth implementation, alone or in combination with one or more of the first through ninth implementations, any of processes 500, 600, or 700 includes receiving information associated with the manual input, and updating the one or more fields associated with the manual input based at least in part on the information.

In an eleventh implementation, alone or in combination with one or more of the first through tenth implementations, the input automatically inserted comprises one or more pairs of access type and dataset location of sensitive data.

In a twelfth implementation, alone or in combination with one or more of the first through eleventh implementations, any of processes 500, 600, or 700 includes transmitting a request for approval of the data assessment document based at least in part on detection of completion of the data assessment document.

In a thirteenth implementation, alone or in combination with one or more of the first through twelfth implementations, any of processes 500, 600, or 700 includes detecting an update to the data assessment document, and transmitting an additional request for approval based at least in part on one or more of determining that the update includes a change from a previous version, wherein the change satisfies a threshold, a field withing the data assessment document associated with one or more changes associated with the update.

In a fourteenth implementation, alone or in combination with one or more of the first through thirteenth implementations, any of processes 500, 600, or 700 includes generating control information associated with the data assessment document, wherein the control information identifies credentials for permissions to modify one or more fields of the data assessment document.

In a fifteenth implementation, alone or in combination with one or more of the first through fourteenth implementations, any of processes 500, 600, or 700 includes generating a human-readable document based at least in part on the data assessment document.

In a sixteenth implementation, alone or in combination with one or more of the first through fourteenth implementations, any of processes 500, 600, or 700 includes permitting merging of the code into a main source control repository based at least in part on approval of the data assessment document.

Although FIGS. 5-7 show example blocks of processes 500, 600, or 700, in some implementations, any of processes 500, 600, or 700may include additional blocks, fewer blocks, different blocks, or differently arranged blocks than those depicted in FIGS. 5-7. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
scanning code of a software solution that uses data inputs and one or more datasets associated with the code, the scanning including identification of sensitive data if present; and
generating a data assessment document automatically and based at least in part on the scanning.

2. The method of claim 1, further comprising updating the data assessment document based at least in part on one or more of:
an update to the code,
an updated scan of the code,
a request to update the data assessment document,
an updated scan of the one or more datasets associated with the code,
a change of a size of the one or more datasets,
a change of a location of the one or more datasets, or
an update to identification of sensitive data.

3. The method of claim 2, further comprising detecting the update to the code based at least in part on one or more of:
submission of an update to the software solution; or
reception of an input that indicates the update of the code.

4. The method of claim 1, wherein scanning the code and the one or more datasets is based at least in part on one or more of:
submission of the code as a draft in a development workflow, or
a request to merge the code into a main source control repository.

5. The method of claim 1, wherein the one or more datasets comprise one or more read datasets used as data inputs or one or more written datasets.

6. The method of claim 5, wherein scanning the one or more datasets comprises detecting whether sensitive data is present based at least in part on metadata of the one or more datasets,
wherein generating the data assessment document comprises populating one or more fields of the data assessment document with the metadata.

7. The method of claim 1, wherein generating the data assessment document comprises:
generating the data assessment document as a machine-readable document.

8. The method of claim 7, wherein the machine-readable document comprises:
indications of sensitive data if present, and
metadata associated with the one or more datasets.

9. The method of claim 1, wherein the data assessment document comprises:
one or more fields having input automatically inserted based at least in part on the sensitive data if present,
one or more fields associated with manual input.

10. The method of claim 9, further comprising:
identifying contact information for a person associated with the one or more manual fields; and
sending, via the contact information, a request for the manual input.

11. The method of claim 1, further comprising:
receiving information associated with the manual input; and
updating the one or more fields associated with the manual input based at least in part on the information.

12. The method of claim 1, wherein the input automatically inserted comprises one or more pairs of access type and dataset location of sensitive data.

13. The method of claim 1, further comprising:
transmitting a request for approval of the data assessment document based at least in part on detection of completion of the data assessment document.

14. The method of claim 13, further comprising detecting an update to the data assessment document; and
transmitting an additional request for approval based at least in part on one or more of:
determining that the update includes a change from a previous version, wherein the change satisfies a threshold;
a field withing the data assessment document associated with one or more changes associated with the update.

15. The method of claim 1, further comprising generating control information associated with the data assessment document,
wherein the control information identifies credentials for permissions to modify one or more fields of the data assessment document.

16. The method of claim 1, further comprising generating a human-readable document based at least in part on the data assessment document.

17. A computer program product comprising:
one or more computer readable storage media, and program instructions collectively stored on the one or more computer readable storage media, the program instructions comprising:
program instructions to scan code of a software solution that uses data inputs and one or more datasets associated with the code, the scanning including identification of sensitive data if present; and
program instructions to generate a machine-readable data assessment document based at least in part on the scanning.

18. The computer program product of claim 17, wherein the program instructions comprise:
program instructions to update the machine-readable data assessment document based at least in part on detecting an update to the code.

19. A computer system comprising:
a processor set;
one or more computer-readable storage media; and
program instructions stored on the one or more storage medium to cause the processor set to perform operations comprising:
scanning code of a software solution that uses data inputs and one or more datasets associated with the code, scanning including identification of sensitive data if present;
generating a data assessment document and based at least in part on the scanning;
detecting an update to the software solution;
re-scanning the code of the software solution and the one or more datasets, the re-scanning including identification of sensitive data if present; and
generating an update to the data assessment document based at least in part on the re-scanning.

20. The computer system of claim 19, wherein detecting the update to the software solution comprises:
detecting submission of an update to the software solution to a development workflow; or
receiving an input that indicates the update of the code.
